(19) United States
(12) Patent Application Publication
(10) Pub. No.: US 2010/0245166 A1
(43) Pub. Date: Sep. 30, 2010

(54) TURBULENCE PREDICTION OVER EXTENDED RANGES

(75) Inventors: James C. Kirk, Clarksville, MD (US); Dongsong Zeng, Germantown, MD (US)

Correspondence Address: HONEYWELL/BLG;Patent Services, 101 Columbia Road, PO Box 2245, Morristown, NJ, 07962-2245, US

(73) Assignee: HONEYWELL INTERNATIONAL INC., Morristown, NJ (US)

(21) Appl. No.: 12/695,614

(22) Filed: Jan. 28, 2010

Related U.S. Application Data
(60) Provisional application No. 61/163,362, filed on Mar. 25, 2009.
(60) Provisional application No. 61/163,355, filed on Mar. 25, 2009.

(51) Int. Cl. G01S 13/95

(52) U.S. Cl. 342/26 B; 342/26 R

(57) ABSTRACT

Methods and systems for predicting turbulence. An exemplary system decomposes near-range reflectivity data into multiple adaptive, three-dimensional Gaussian component functions and decomposes turbulence data into multiple adaptive, three-dimensional Gaussian component functions. The multiple adaptive, three-dimensional Gaussian component functions may include parameters, such as center position, amplitude, and dimensional standard deviations that are determined adaptively to maximally match the measured reflectivity. The multiple adaptive, three-dimensional Gaussian component functions may include parameters adjusted to maximally match the measured turbulence data.

### PRIORITY CLAIM

This application claims the benefit of U.S. Provisional Application Ser. Nos. 61/163,362 and 61/163,355 both filed Mar. 25, 2009, the contents of which are hereby incorporated by reference.

### BACKGROUND OF THE INVENTION

One danger or threat to an aircraft is from weather that includes turbulent air. Sudden updrafts, downdrafts, or wind shears can inflict injury on occupants and damage to the aircraft, or cause the total loss of aircraft and passengers. Turbulent air itself cannot be accurately measured by radar at any significant range, but such turbulence generally is accompanied by rain, hail, or particulate matter that can be. At short ranges (currently approximately up to 40 nautical miles (nm) from the aircraft), airborne Doppler radar information can give a direct reading of the movement of airborne particles and, hence, a fairly direct measure of air turbulence and potential hazard. However, current practical airborne radars that are affordable and fit on commercial aircraft do not have the ability to measure Doppler effects much farther than this, giving too little reaction time for the pilots to plan effective and efficient routes around the hazard.

### SUMMARY OF THE INVENTION

The present invention provides methods and systems for predicting turbulence over an extended range. An exemplary method includes decomposing radar reflectivity data into multiple adaptive three-dimensional Gaussian component functions and decomposing turbulence data into multiple adaptive three-dimensional Gaussian component functions.

The real measured turbulence data t(x,y,z) is shown in FIG. 1-1.

The present invention provides adaptive signal decomposition and a neural network method to extend the weather radar turbulence prediction range from 40 nm to 320 nm (approximate radar limit). With the decomposed reflectivity and turbulence components as the input and output, a proposed backward propagation neural network learns the relationship between reflectivity and turbulence. The trained neural network then predicts the turbulence at an extended range where only reflectivity data are available. Advantageously, the adaptive signal decomposition method may be used for object tracking, such as, but not limited to, weather tracking, cloud tracking, bird flock tracking, aircraft tracking, etc.

### BRIEF DESCRIPTION OF THE DRAWINGS

Preferred and alternative embodiments of the present invention are described in detail below with reference to the following drawings:

FIGS. 1-1 thru 1-23, are algorithms used throughout the application;

FIG. 2 illustrates an exemplary system formed in accordance with an embodiment of the present invention;

FIGS. 3-1 thru 3-4 illustrate actual near-range radar reflectivity and turbulence data;

FIGS. 4 and 5 illustrate an exemplary process for training a neural network in accordance with an embodiment of the present invention;

FIG. 6 illustrates a graphical manipulation used by the present invention for calculation improvement;

FIG. 7 illustrates a schematic of an exemplary neural network; and

FIG. 8 illustrates a process for determining far-range turbulence values based on the trained neural network.

### DETAILED DESCRIPTION OF ONE EMBODIMENT

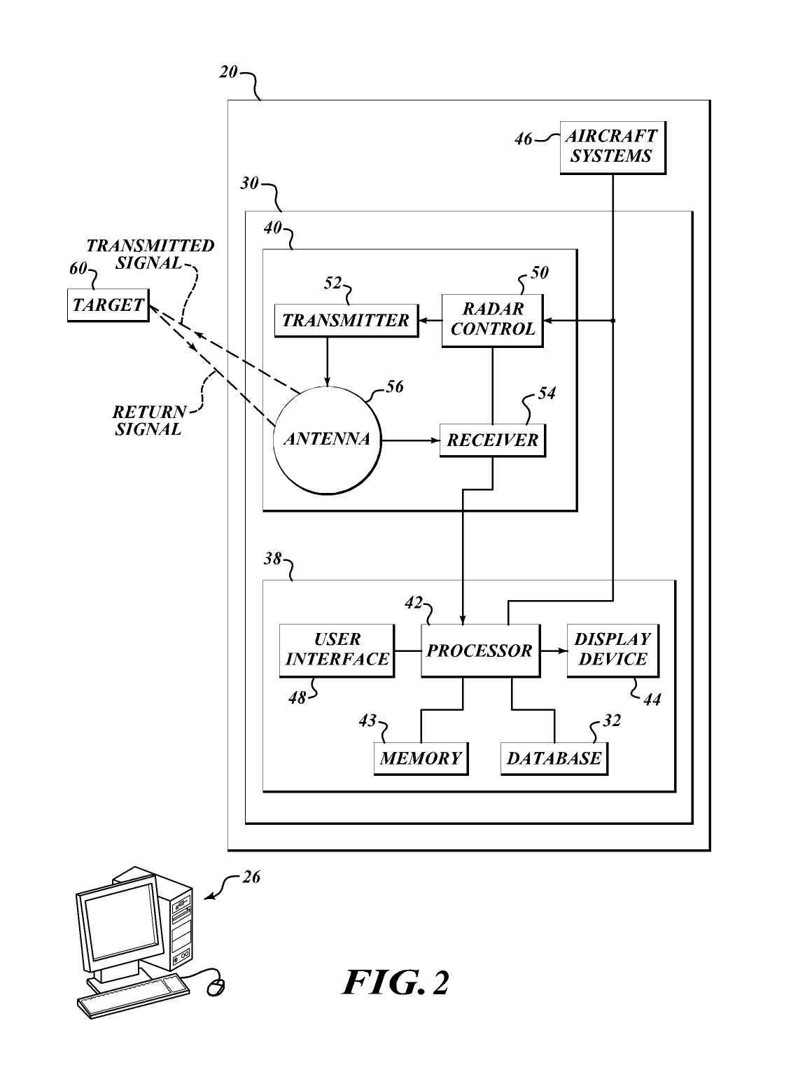

FIG. 2 illustrates a weather display system 30 on an aircraft that provides turbulence prediction at extended ranges. The weather display system 30 provides an improved radar return. The weather display system 30 includes a weather radar system 40 and a display/interface front-end 38. The weather display system 30 receives information from other aircraft systems 46. The display/interface front-end 38 includes a processor 42, memory 43, a display device 44, a user interface 48, and a database 32. An example of the radar system 40 includes a radar controller 50 (configured to receive control instructions from the user interface 48), a transmitter 52, a receiver 54, and an antenna 56. The radar controller 50 controls the transmitter 52 and the receiver 54 for performing the sending and receiving of signals through the antenna 56. The weather radar system 40 and the display/interface front-end 38 are electronically coupled to the other aircraft systems 46.

Radar relies on a transmission of a pulse of electromagnetic energy, referred to herein as a signal. The antenna 56 narrowly focuses the transmission of the signal pulse. Like the light from a flashlight, this narrow signal illuminates any objects in its path and illuminated objects reflect the electromagnetic energy back to the antenna.

Reflectivity data correspond to that portion of a radar's signal reflected back to the radar by liquids (e.g., rain) and/or frozen droplets (e.g., hail, sleet, and/or snow) residing in a weather object, such as a cloud or storm, or residing in areas proximate to the cloud or storm generating the liquids and/or frozen droplets.

The radar controller 50 calculates the distance of the weather object relative to the antenna 56 based upon the length of time the transmitted signal pulse takes in the transition from the antenna 56 to the object and back to the antenna 56. The relationship between distance and time is linear as the velocity of the signal is constant, approximately the speed of light in a vacuum. Honeywell's® RDR-4000 airborne weather radar is an example weather radar that provides the radar reflectivity data and the short range Doppler radar information.

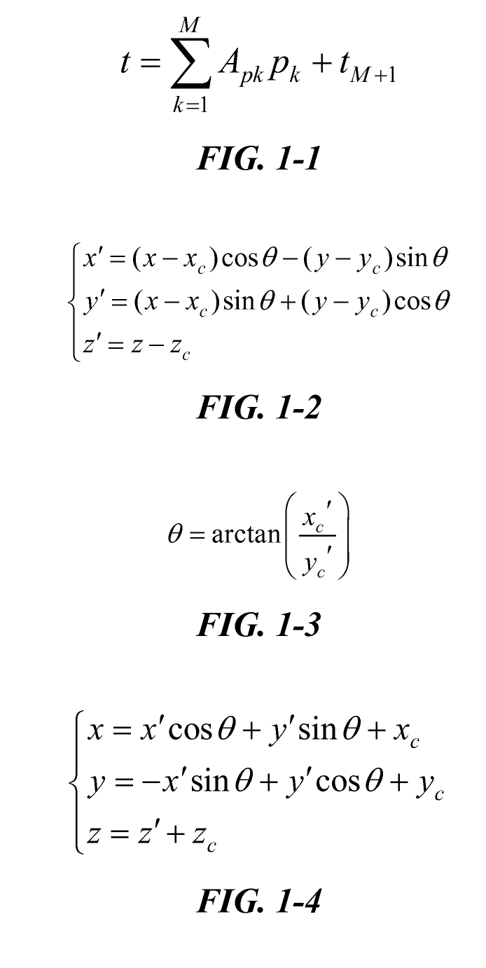

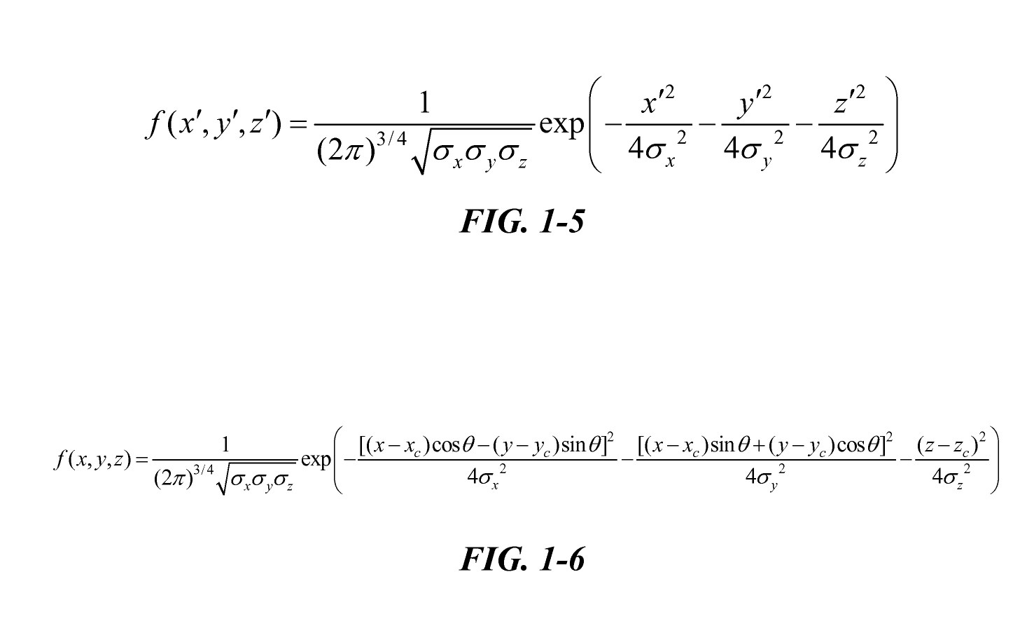

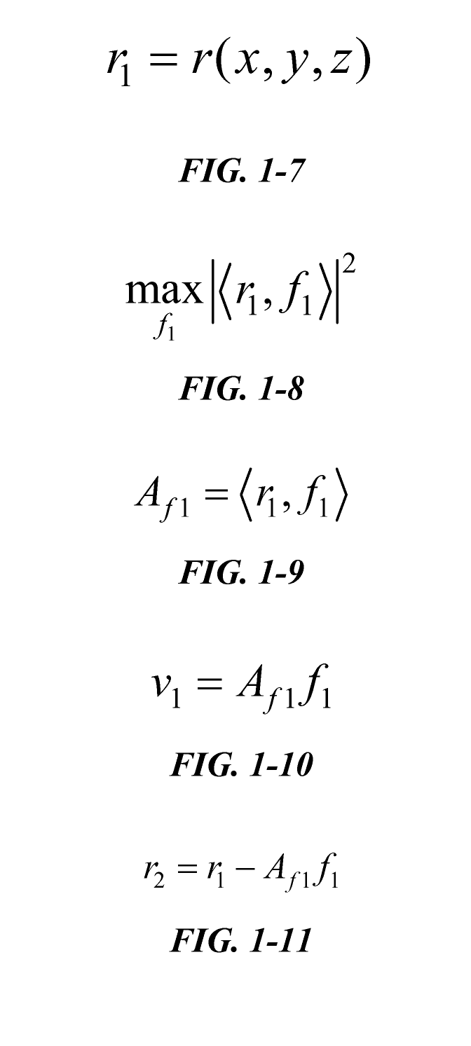

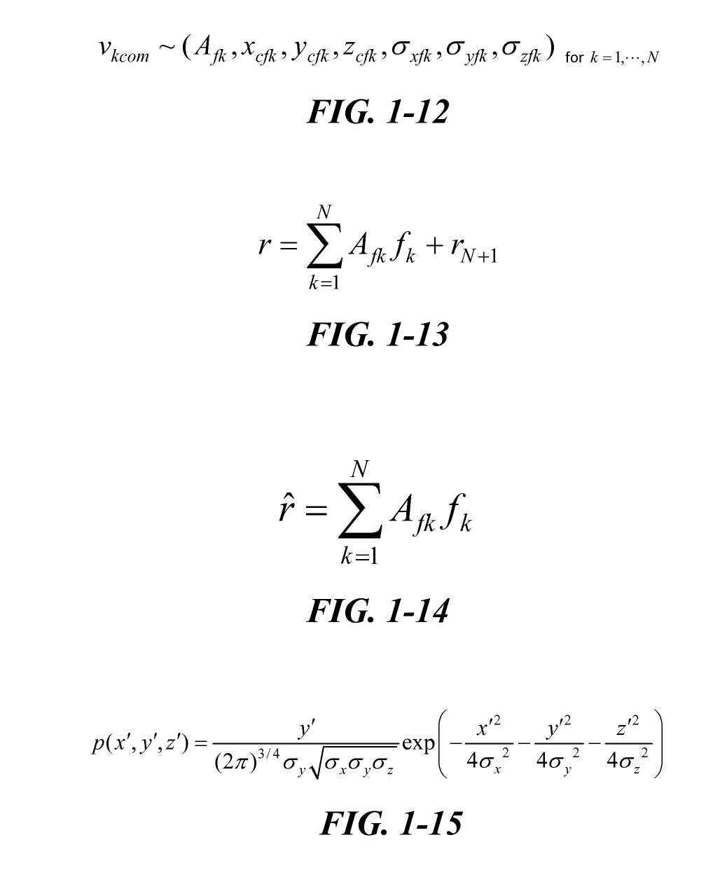

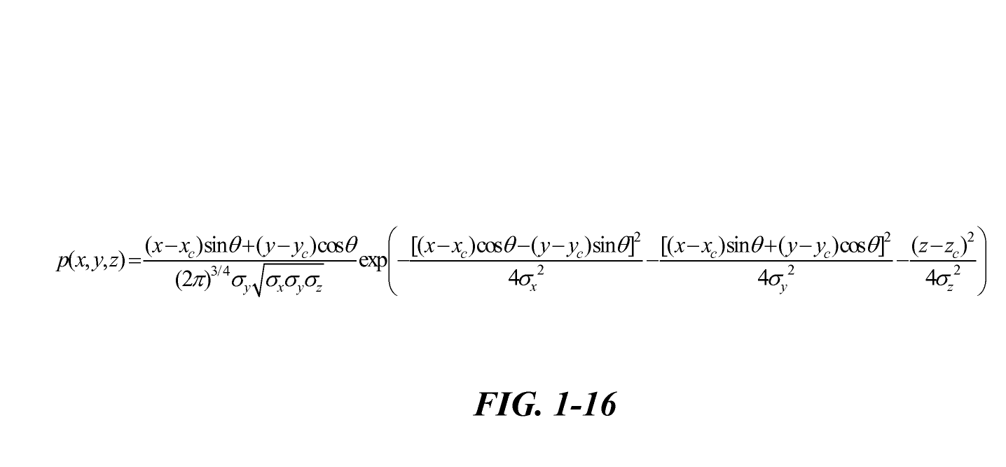

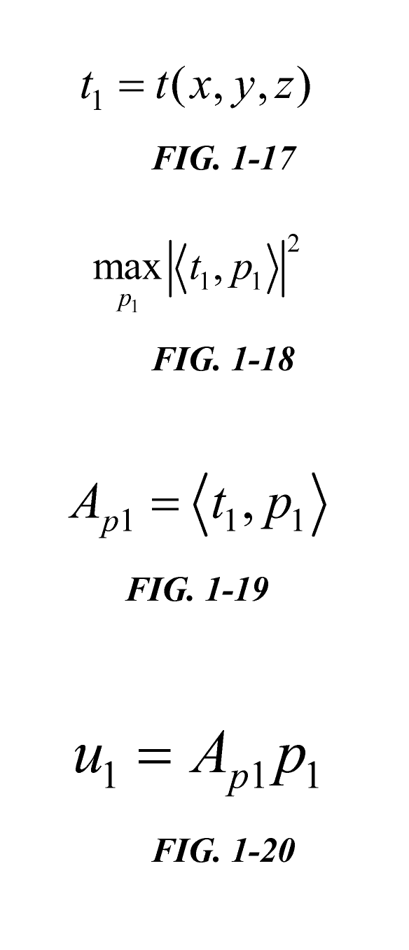

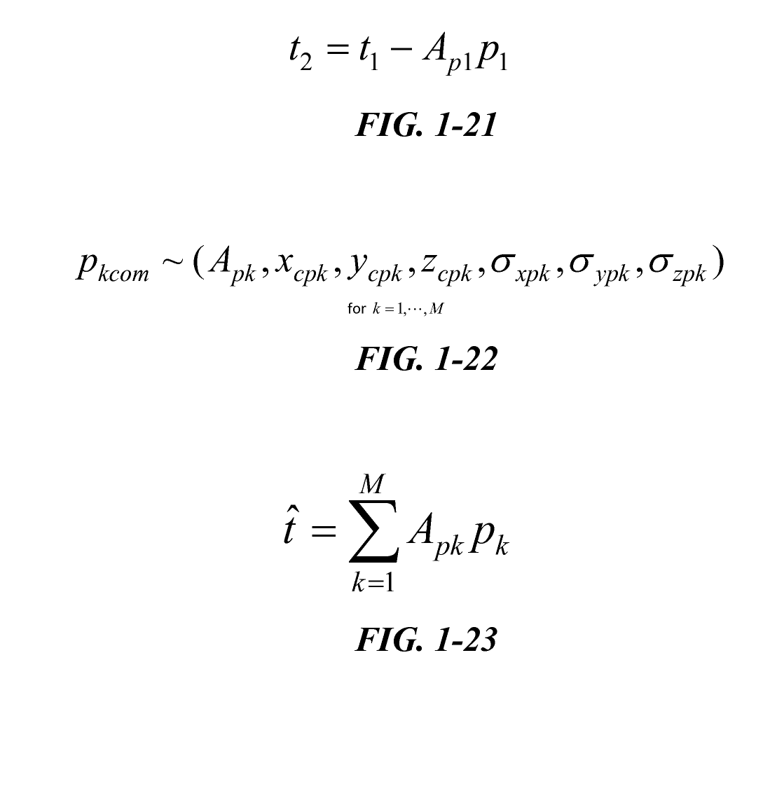

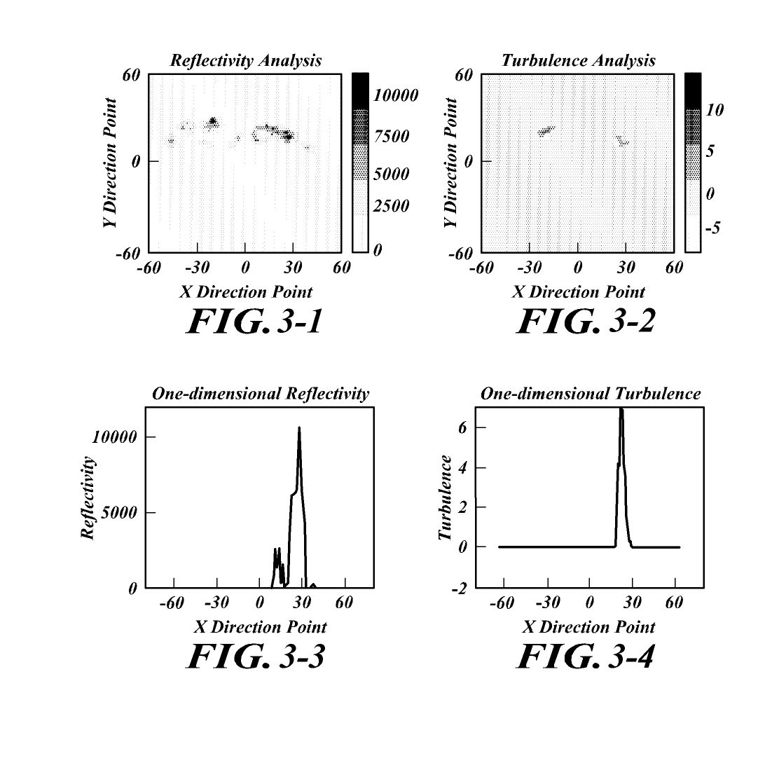

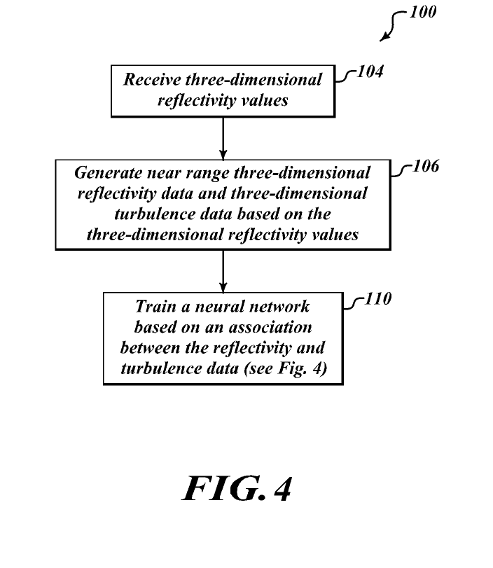

FIGS. 3-1 THRU 3-4 show actual radar reflectivity and turbulence data. Although both reflectivity and turbulence data are three-dimensional, for visualization reasons, the data is presented in only one and two dimensions. FIGS. 3-1 and 3-2 show two-dimensional reflectivity and turbulence, respectively. FIGS. 3-3 and 3-4 show one-dimensional reflectivity and turbulence, respectively. From FIGS. 3-1 and 3-4, it is observed that the reflectivity and turbulence data are all positive and look like the sum of multiple Gaussian functions.

In one embodiment, the present invention includes turbulence prediction systems and methods using adaptive signal decomposition and a neural network's approach to forecast turbulence information beyond the 40 nm range. An exemplary method includes reflectivity signal decomposition and turbulence signal decomposition. The method decomposes the reflectivity data into multiple adaptive, three-dimensional Gaussian component functions, whose parameters, such as center position, amplitude, and dimensional standard deviations, are determined adaptively to maximally match the measured reflectivity. Performing the reflectivity signal decomposition includes using adaptive three-dimensional Gaussian base functions with unit energy. The turbulence data are decomposed into adaptive three-dimensional Gaussian base functions, with their parameters adjusted to maximally match the measured turbulence data.

With the decomposed reflectivity and turbulence components as input and output, backward propagation of the neural network is performed for learning the relationship between reflectivity and turbulence. The trained neural network is then used to predict the turbulence at an extended range where only reflectivity data are available. The adaptive signal decomposition method proposed herein may also be used for object tracking, e.g., weather/cloud tracking, bird flock tracking, aircraft tracking, etc.

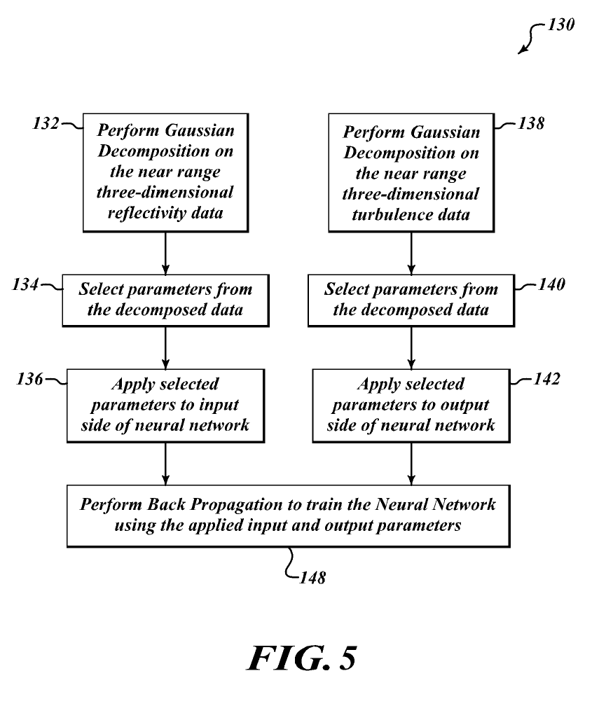

FIG. 4 illustrates an exemplary process 100 that performs training of a neural network using reflectivity and turbulence values in accordance with an embodiment of the present invention. First, at a block 104, three-dimensional reflectivity values are received from a radar system. Next, at a block 106, near-range three-dimensional reflectivity data and three-dimensional turbulence data based on the three-dimensional reflectivity values are generated. Next, at a block 110, the process 100 trains a neural network based on an association between the generated three-dimensional reflectivity data and the three-dimensional turbulence data. The training step is described in more detail below with regard to FIG. 5.

FIG. 5 illustrates a process 130 that describes the training of the neural network in more detail. At a block 132, a Gaussian decomposition of the near-range three-dimensional reflectivity data is performed. Next, at a block 134, parameters from the decomposed reflectivity data are selected. Then, at a block 136, the selected parameters are applied to an input side of a neural network that needs to be trained. Concurrent with blocks 132-136, a Gaussian decomposition is performed on the near-range three-dimensional turbulence data. Next, at a block 140, parameters are selected from the decomposed turbulence data. At a block 142, the selected turbulence data parameters are applied to an output side of the untrained neural network. Finally, at a block 148, backward propagation of the untrained neural network is performed, using the applied input and output parameters, thereby training the neural network.

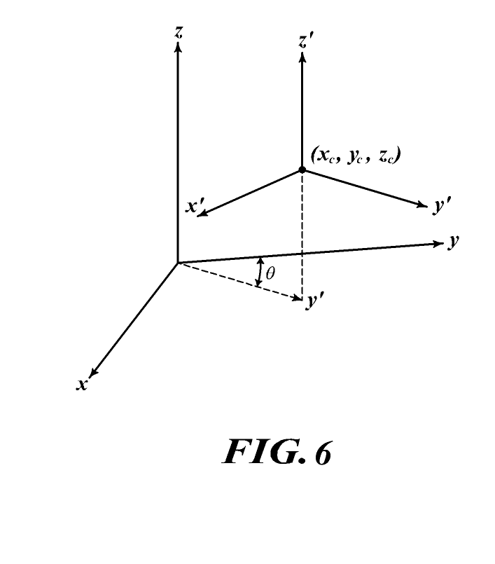

FIG. 6 shows that, for the convenience of computation, a coordinate change may be necessary and includes moving the origin of the xyz coordinates to point (x_{c},y_{c},z_{c}) and clockwise rotating they coordinate θ results in new x′y′z′ coordinates.

The new coordinates after coordinate change are calculated as shown in FIG. 1-2.

The rotation angle θ is calculated as shown in FIG. 1-3.

The transform from new coordinates back to old coordinates is shown in FIG. 1-4.

Adaptive Decomposition of Reflectivity: The following equations show the adaptive decomposition of reflectivity. The three-dimensional Gaussian base function is proposed, as shown in FIG. 1-5:

which has unit energy, i.e., ∫∫∫f²(x′,y′,z′)dx′dy′dz′=1. Placing equation (1) into equation (4), the three-dimensional Gaussian base function in xyz coordinates is shown in FIG. 1-6.

At initialization, the current reflectivity r₁ is set to the measured reflectivity data r(x,y,z), i.e., shown in FIG. 1-7.

The center position and dimensional deviations of the three-dimensional Gaussian base function are determined by solving the following optimization problem, where [symbol] means inner product shown in FIG. 1-8.

The amplitude of the Gaussian base function is calculated as shown in FIG. 1-9.

The first reflectivity component function v₁ is therefore shown in FIG. 1-10.

Removing the first component function v₁ from the original reflectivity data r₁, a new reflectivity r₂ data is attained, i.e., shown in FIG. 1-11.

Repeating the above procedure for N iterations, there become N reflectivity component functions shown in FIG. 1-12.

The real measured data r(x,y,z) is shown in FIG. 1-13.

It is interesting to note that the residual of the adaptive decomposition is always bounded. For continuous signal r, the residual will be reduced to zero as the number of iterations N goes to infinity.

Ignoring the residual r_{N+1}, the N component functions are used to approximate the reflectivity function as shown in FIG. 1-14.

Adaptive Decomposition of Turbulence: The following equations show the adaptive decomposition of turbulence. The turbulence base function is proposed, as shown in FIG. 1-15.

This turbulence base function also has unit energy, i.e., ∫∫∫p²(x′,y′,z′)dx′dy′dz′=1. Placing the equation of FIG. 1-2 into the equation of FIG. 1-15, the turbulence base function in xyz coordinates is represented as shown in FIG. 1-16.

At initialization, the measured turbulence data t(x,y,z) are assigned to the current turbulence t₁, i.e., shown in FIG. 1-17.

The parameters of the turbulence base function are determined by solving the following optimization problem shown in FIG. 1-18.

The amplitude of the turbulence base function is calculated as shown in FIG. 1-19.

The first turbulence component function u₀ is shown in FIG. 1-20.

Removing the first component function u₁ from the original turbulence data t₁, a new turbulence data t₂ is attained, i.e., as shown in FIG. 1-21.

Repeating the above procedure for M iterations, M component functions are shown in FIG. 1-22.

Ignoring the residual t_{M+1}, the M component functions are used to reconstruct the turbulence function as shown in FIG. 1-23.

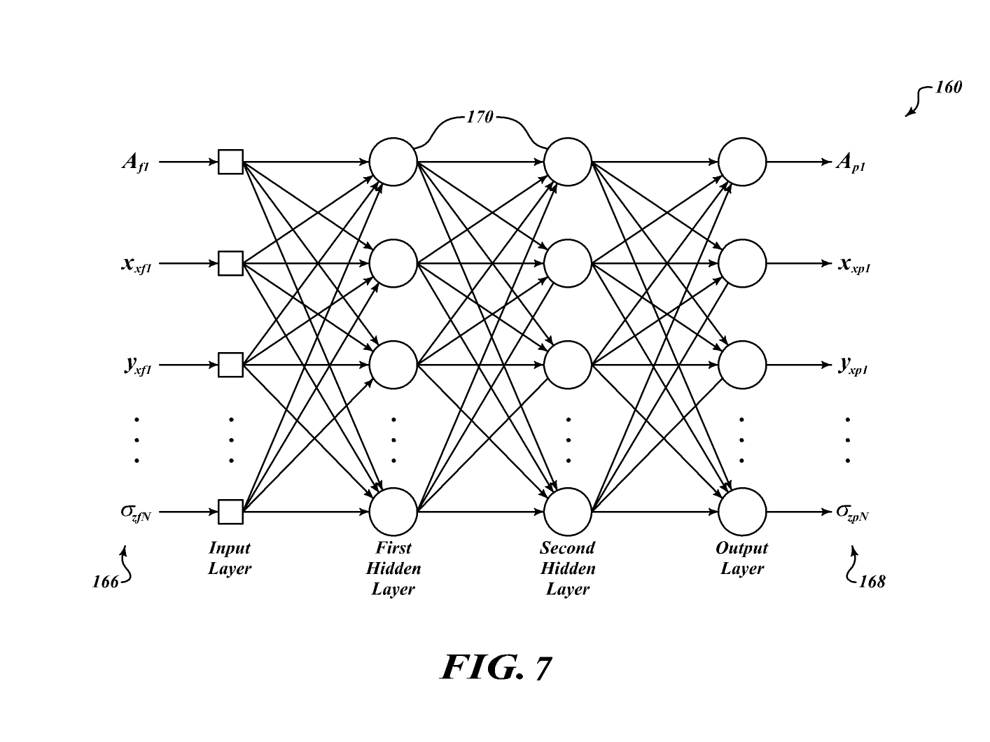

FIG. 7 shows a three-layer backward propagation neural network 160 having inputs 166, outputs 168, and nodes 170. Other back propagation neural network architectures may be used.

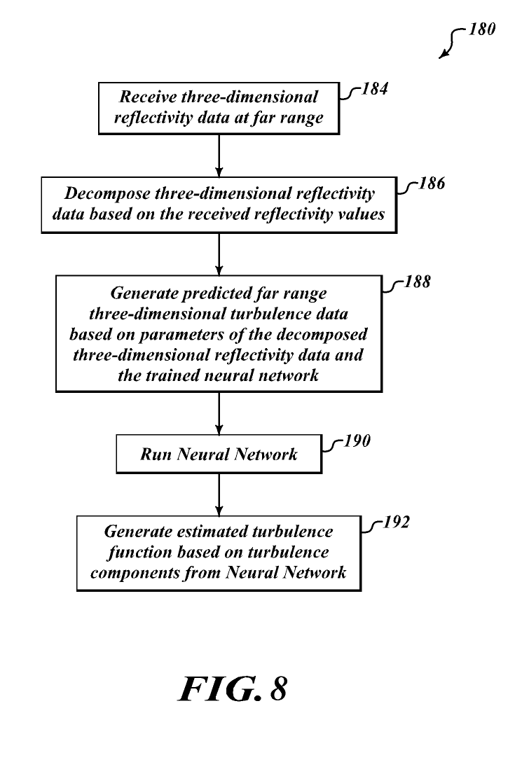

Beyond ˜40 nm, the weather radar can effectively measure only reflectivity. The measured reflectivity data is decomposed into reflectivity components (FIG. 8, blocks 184, 186). Then, at a block 188, decomposed reflectivity components (parameters) are applied as the input 166 to the trained neural network 160. The neural network 160 is then executed, thus producing predicted turbulence components (block 190, output 168). At a block 192, the produced predicted turbulence components are reconstructed into an estimated turbulence function. This estimated turbulence function will be the predicted turbulence for the ranges greater than 40 nm, where turbulence storage cells are otherwise left empty, due to low weather radar resolution.

While one embodiment of the invention has been illustrated and described, as noted above, many changes can be made without departing from the spirit and scope of the invention. For example, processors are used to automatically perform the steps shown and described in the flowcharts above. Accordingly, the scope of the invention is not limited by the disclosure of one embodiment. Instead, the invention should be determined entirely by reference to the claims that follow.

The embodiments of the invention in which an exclusive property or privilege is claimed are defined as follows:

1. A method for predicting turbulence at ranges greater than 40 nm using at least one processing device, the method comprising:
receiving radar reflectivity and turbulence data at ranges less than 40 nm;
generating a neural network based on the received data;
receiving radar reflectivity data at ranges greater than 40 nm; and
predicting turbulence data based on the received radar reflectivity data at ranges greater than 40 nm and the generated neural network.

2. The method of claim 1, wherein generating a neural network comprises:
decomposing the received radar reflectivity data into multiple adaptive, three-dimensional Gaussian component functions; and
decomposing the received turbulence data into multiple adaptive, three-dimensional Gaussian component functions.

3. The method of claim 2, wherein generating a neural network comprises:
selecting one or more first parameters from the multiple adaptive, three-dimensional Gaussian component functions;
selecting one or more second parameters from the multiple adaptive, three-dimensional Gaussian component functions;
applying the one or more first parameters to one of an input or output side of the neural network; and
applying the one or more second parameters to a side of the neural network opposite the side with the applied first parameters.

4. The method of claim 3, wherein the parameters comprise one or more of a center position, an amplitude, and a dimensional standard deviation.

5. The method of claim 3, wherein generating the neural network is performed at a processing device remotely located from the processing device performing receiving radar reflectivity and turbulence data and predicting turbulence data.

6. The method of claim 5, further comprising distributing the parameters to aircraft other than the aircraft with the processing device that received the radar reflectivity and turbulence data.

7. A turbulence prediction system at least partially located on an aircraft, the system comprising:
a radar system configured to generate radar reflectivity data at ranges greater than 40 nm; and
a processing device in signal communication with the radar system, the processing device configured to predict turbulence data based on the received radar reflectivity data and a neural network previously trained using radar reflectivity and turbulence data at ranges less than 40 nm,
wherein the radar system and the processing device are located on an aircraft.

8. The system of claim 7, further comprising a second processing device configured to train the neural network, the second processing device being configured to:
decompose the less than 40 nm radar reflectivity data into multiple adaptive, three-dimensional Gaussian component functions; and
decompose the turbulence data into multiple adaptive, three-dimensional Gaussian component functions.

9. The system of claim 8, wherein the second processing device is further configured to:
select one or more first parameters from the multiple adaptive, three-dimensional Gaussian component functions;
select one or more second parameters from the multiple adaptive, three-dimensional Gaussian component functions;
apply the one or more first parameters to one of an input or output side of the neural network; and
apply the one or more second parameters to a side of the neural network opposite the side with the applied first parameters.

10. The system of claim 9, wherein the parameters comprise one or more of a center position, an amplitude, and a dimensional standard deviation.

11. The system of claim 9, wherein the first and second processing devices are the same device and the processing of both processing devices is performed in real time.

12. The system of claim 9, wherein the second processing device is remotely located from the aircraft.

13. A system for predicting turbulence at ranges greater than 40 nm using a processing device, the system comprising:
a means for receiving radar reflectivity and turbulence data at ranges less than 40 nm;
a means for generating a neural network based on the received data;
a means for receiving radar reflectivity data at ranges greater than 40 nm; and
a means for predicting turbulence data based on the received radar reflectivity data at ranges greater than 40 nm and the generated neural network.

14. The system of claim 13, wherein the means for generating a neural network comprises:
a means for decomposing the received radar reflectivity data into multiple adaptive, three-dimensional Gaussian component functions; and
a means for decomposing the received turbulence data into multiple adaptive, three-dimensional Gaussian component functions.

15. The system of claim 14, wherein the means for generating a neural network comprises:
a means for selecting one or more first parameters from the multiple adaptive, three-dimensional Gaussian component functions;
a means for selecting one or more second parameters from the multiple adaptive, three-dimensional Gaussian component functions;
a means for applying the one or more first parameters to one of an input or output side of the neural network; and
a means for applying the one or more second parameters to a side of the neural network opposite the side with the applied first parameters.

16. The system of claim 15, wherein the parameters comprise one or more of a center position, an amplitude, and a dimensional standard deviation.
